(19) United States
(12) Patent Application Publication
(10) Pub. No.: US 2004/0043786 A1
(43) Pub. Date: Mar. 4, 2004

(54) Communication terminal apparatus and mobile radio terminal apparatus

(75) Inventor: Masamichi Togawa, Musashimurayama-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/650,840

(22) Filed: Aug. 29, 2003

(30) Foreign Application Priority Data
Aug. 30, 2002 (JP) 2002-252373

(51) Int. Cl. H04M 1/00

(52) U.S. Cl. 455/550.1; 455/566

(57) ABSTRACT

A control section preliminarily stores in a memory section hands-free setting data indicating whether or not a hands-free communication function is set before connection of a car kit and, if the car kit is disconnected, resets the data to an operated condition before the car kit has been connected.

### CROSS-REFERENCE TO RELATED APPLICATIONS

This application is based upon and claims the benefit of priority from the prior Japanese Patent Application No. 2002-252373, filed Aug. 30, 2002, the entire contents of which are incorporated herein by reference.

### BACKGROUND OF THE INVENTION

1. Field of the Invention

This invention relates to a communication terminal apparatus for use in, for example, a radio communication system such as a portable telephone system.

2. Description of the Related Art

When a mobile radio terminal apparatus for a mobile communication system such as a portable telephone system or the like is used, a microphone thereof is brought close to a user's mouth and a loudspeaker thereof to a user's ear. Other than this general use, a hands-free communication function can selectively be employed.

The hands-free communication function allows the user to make communications by enhancing the sensitivity of the microphone and turning up the volume of the speech from the loudspeaker, and by only placing the terminal apparatus near the user without holding the mobile radio terminal apparatus in his hand. According to this function, the user can make communications while doing some work.

Recently, some kinds of terminal apparatus have been provided with a videophone function which allows the user to make communications while viewing an image of a communication partner, or a game function. When the user makes communications while using such a function, the user holds the terminal apparatus in his hand without bringing it close to the user's face. Thus, the hands-free communication function is useful for the terminal apparatus comprising such a function.

Incidentally, if an optional unit (for example, a car kit or an earphone-microphone) comprising a speech input/output function is connected to the terminal apparatus, setting of the terminal apparatus is automatically changed to use the optional unit and communications are made by the optional unit.

For example, if the user connects the terminal apparatus to the car kit while making communications by the hands-free communication function, setting is automatically changed to make communications through a microphone and a loudspeaker which are built in the car kit.

After that, if the terminal apparatus is disconnected from the car kit during the communications using the car kit, the sensitivity of the microphone and the volume of the speech from the loudspeaker are changed to correspond to the setting of the general communication manner.

However, the user who frequently uses the hands-free communication function is considered to continue using the hands-free communication function even after disconnecting the optional unit from the terminal apparatus.

For this reason, there is inconvenience that if the user who frequently uses the hands-free communication function makes communications through the optional unit and then continues communications after disconnecting the optional unit from the terminal apparatus, the user needs to set again the hands-free communication function in the terminal apparatus.

On the other hand, if the user who frequently uses the general communication manner disconnects the optional unit from the terminal apparatus, the user preferably makes communications, not by the hands-free communication function, but in the general manner.

The conventional terminal apparatus has inconvenience that if the optional unit comprising the speech input/output function is disconnected therefrom, the user needs to reset the speech input/output level.

### BRIEF SUMMARY OF THE INVENTION

The present invention is accomplished to solve the above-explained problem. An object of the present invention is to provide a communication terminal apparatus with good usability wherein even if an optional device having a speech input/output function is disconnected from the terminal apparatus, the user does not need to reset speech input/output levels.

To achieve the above object, a communication terminal apparatus making radio communication according to the present invention is configured to comprise a speaker, a microphone, a first amplifier which varies a level of a speech signal to be outputted by the speaker, a second amplifier which varies a level of a speech signal inputted by the microphone, a first memory which stores first information for respectively setting the gains of the first and second amplifiers at predetermined values, and for storing second information for respectively setting the gains of the first and second amplifiers at predetermined values different from the values of the first information, means for designating any one of the first and second information, a second memory which stores the information designated by the designating means, means for controlling the gains of the first and second amplifiers based on the designated information stored in the second memory, means for connecting to an external device capable of speech input/output, means for detecting a connection to the external device and a disconnection from the external device and means for switching the speech input/output by the microphone and speaker to the speech input/output by the external device when the detecting means detects the connection to the external device, and for switching the speech input/output by the external device to the speech input/output by the microphone and speaker when the detecting means detects the disconnection from the external device.

The controlling means controls the gain of the first and second amplifiers based on the designated information stored in the second memory when the detecting means detects the disconnection from the external device.

That is, in the communication terminal apparatus having the above structure, if the external device is disconnected, the gains of the first amplifier and the second amplifier are controlled on the basis of the gain information which has been set before the external device is connected.

Therefore, according to the communication terminal apparatus, even if the optional device comprising the speech input/output function is disconnected, the user does not need to set again the speech input/output level, and thereby the usability can be improved.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows a block diagram of a structure of a mobile radio terminal apparatus according to an embodiment of the present invention;

FIG. 2 shows a flowchart for explanation of operations of the mobile radio terminal apparatus shown in FIG. 1; and

FIG. 3 shows a block diagram of a mobile radio terminal apparatus according to another embodiment of the present invention.

### DETAILED DESCRIPTION OF THE INVENTION

Embodiments of the present invention will be described below with reference to attached drawings.

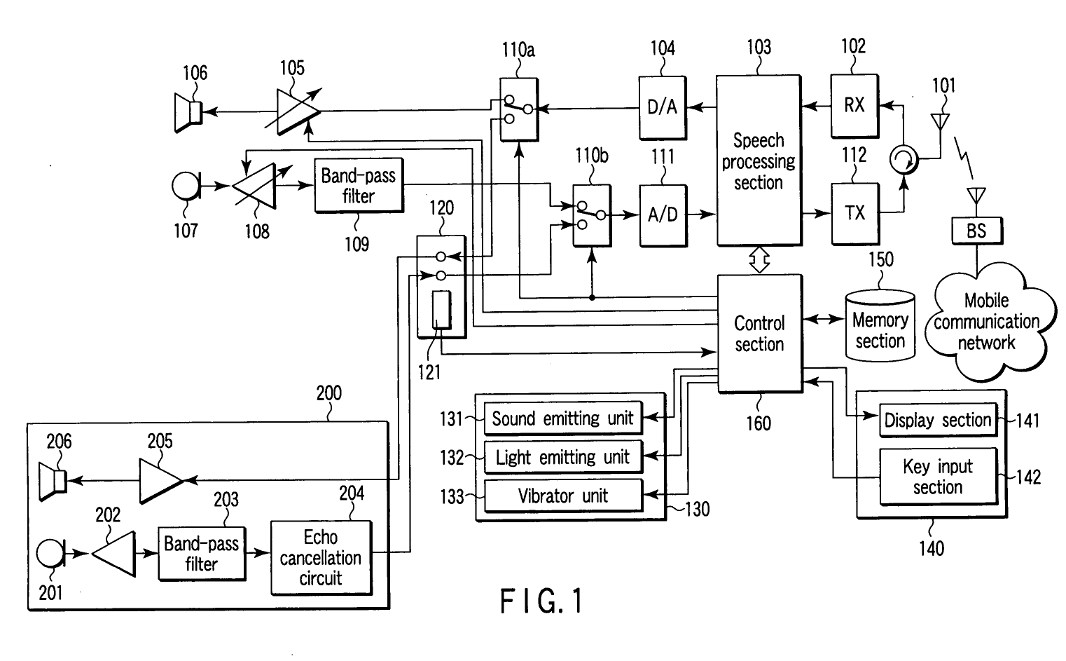

FIG. 1 shows a structure of a mobile radio terminal apparatus according to an embodiment of the present invention.

In this figure, reference numeral 200 denotes a car kit and BS represents a base station apparatus accommodated in a mobile communication network. The remaining sections are included in the mobile radio terminal apparatus.

The mobile radio terminal apparatus comprises an antenna 101, a receiving section (RX) 102, a speech processing section 103, a D/A converter (D/A) 104, an amplifier 105, a loudspeaker 106, a microphone 107, an amplifier 108, a band-pass filter 109, changeover switches 110a and 110b, an A/D converter (A/D) 111, a transmitting section (TX) 112, an external interface 120, an incoming call notifying section 130, a user interface section 140, a memory section 150, and a control section 160.

The base station apparatus BS, which is accommodated in a mobile communication network, connects the mobile radio terminal apparatus and the mobile communication network.

The antenna 101 receives a radio signal transmitted from the base station apparatus BS and outputs it to the receiving section 102.

The receiving section 102 downconverts the received radio signal, demodulates the signal, and outputs the demodulated signal to the speech processing section 103.

The speech processing section 103 performs predetermined decoding processing and the like on the demodulated signal and extracts speech data transmitted from a communication partner.

The D/A converter 104 converts the speech data into an analog speech signal and outputs the signal to the changeover switch 110a.

The changeover switch 110a comprises a first output terminal and a second output terminal. The amplifier 105 is connected to the first output terminal, and the car kit 200 is connected to the second output terminal via the external interface 120.

The changeover switch 110a is controlled by the control section 160 to be explained later, such that the analog speech signal which is input from the D/A converter 104 is output selectively from the first output terminal or the second output terminal.

The amplifier 105 amplifies the analog speech signal which is input through the changeover switch 110a and outputs the amplified signal from the loudspeaker 106. A gain of the amplifier 105 is controlled by the control section 160.

The microphone 107 inputs the user's speech to be transmitted. The transmission speech signal which is input from the microphone 107 is amplified by the amplifier 108 and input to the band-pass filter 109. A gain of the amplifier 108 is controlled by the control section 160.

The band-pass filter 109 has filtering characteristics based on characteristics of the microphone 107 and the like, performs predetermined band limitation on the transmission speech signal which is input through the microphone 107, and outputs the transmission speech signal to a first input terminal of the changeover switch 110b.

The changeover switch 110b comprises the first input terminal and a second input terminal. The transmission speech signal is input to the first input terminal via the band-pass filter 109, and is input to the second input terminal from the car kit to be explained later through the external interface 120.

The changeover switch 110b is controlled by the control section 160 to be explained later, such that either the first input terminal or the second input terminal is connected to an input terminal of the A/D converter 111.

The A/D converter 111 inputs the transmission speech signal via the changeover switch 110b, converts this signal into digital transmission speech data and outputs the transmission speech data to the speech processing section 103.

The speech processing section 103 performs predetermined encoding processing on the transmission speech data and outputs the transmission data obtained by this processing to the transmitting section 112.

The transmitting section 112 modulates a carrier wave with the transmission data which is input from the speech processing section 103, upconverts the modulated carrier wave up to a predetermined radio frequency, processes the upconverted carrier wave in high-frequency amplification, and transmits the carrier wave to the base station apparatus BS through the antenna 101.

The external interface 120 is an external interface which is connected physically and electrically to the optional unit such as the car kit 200 or the like, and comprises a detector 121.

The detector 121 discriminates the optional unit connected to the external interface 120, and notifies the control section 160 of information about connection or disconnection of the optional unit and the kind of the connected optional unit.

If there is an incoming call for the mobile radio terminal apparatus, the incoming call notifying section 130 is operated under control of the control section 160 to notify the user of the incoming call. The incoming call notifying section 130 comprises a sound emitting unit 131, a light emitting unit 132 and a vibrator unit 133.

The user interface section 140 comprises a display section 141 and a key input section 142. The display section 141 is composed of, for example, a LCD (Liquid Crystal Display), an EL (Electro Luminescence) or the like to visually display states (outgoing/incoming calls, a remaining amount of battery, receiving strength) of the own terminal apparatus, dialing data which is read from the memory section 150, and the like, to the user.

The key input section 142 comprises keys for general communication functions relating to outgoing/incoming calls such as a ten-key for dial number input, keys for various setting and functions such as change of the incoming call notification methods (audible sounds/lights/vibration/no notification).

The memory section 150 comprises a semiconductor memory such as a ROM, a RAM or the like as its storage medium. Telephone directory data in which names correspond to telephone numbers and the like, and the other data are stored in the storage medium.

In addition, the memory section 150 stores volume setting data which indicates a gain to be set in the amplifier 105, microphone sensitivity data which indicates a gain to be set in the amplifier 108, hands-free gain data which indicates gains to be set in the amplifiers 105 and 108 when the hands-free communication function is performed, and hands-free setting data which indicates whether the hands-free communication function is set or not.

The control section 160 comprises a CPU, a ROM, a RAM and the like. The CPU controls the sections of the mobile radio terminal apparatus on the basis of the control program and control data stored in the ROM.

A function of performing the hands-free communication function is one of the control functions of the control section 160. When this control function is required to perform the hands-free communication function through the key input section 142, the control section 160 controls the gains of the amplifiers 105 and 108 on the basis of the hands-free gain data which is stored in the memory section 150, turns up the volume of the speech from the loudspeaker 106, and increases the sensitivity of the microphone 107. The user can thereby make communications without holding the mobile radio terminal apparatus in his hand.

The control section 160 also has a function of referring to the hands-free setting data and controlling the gains of the amplifiers 105 and 108, in response to the disconnection of the car kit 200.

Next, the car kit 200 will be explained. The car kit 200 is an optional unit which is installed in an automobile or the like, and comprises a microphone 201 and a loudspeaker 206 to perform speech input/output instead of the loudspeaker 106 and the microphone 107 of the mobile radio terminal apparatus.

In addition, the car kit 200 comprises a function of feeing electric power obtained from the automobile to the mobile radio terminal apparatus and connecting an external antenna to the mobile radio terminal apparatus, though omitted in the figure for simplicity of the explanation.

The microphone 201 inputs the user's transmission speech. The input transmission speech signal is amplified by an amplifier 202 and is input to a band-pass filter 203.

The band-pass filter 203 has filtering characteristics based on characteristics of the microphone 201 and the like, performs predetermined band limitation on the transmission speech signal which is input through the microphone 201, and outputs the transmission speech signal to an echo cancellation circuit 204.

The echo cancellation circuit 204 is an echo canceller which removes echo components resulting from the speech from a loudspeaker (not shown) of the car kit 200. The transmission speech signal from which the echo components are removed is output to the second input terminal of the changeover switch 110b through the external interface 120.

An amplifier 205 amplifies the analog speech signal which is input through the external interface 120 and outputs the amplified analog speech signal from the loudspeaker 206.

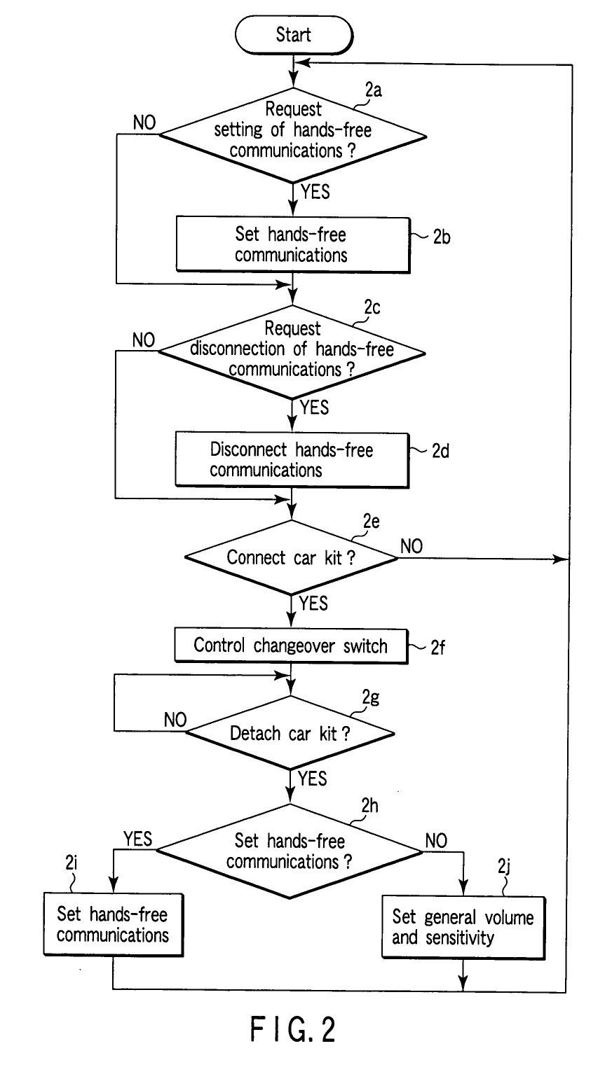

Next, operations of the mobile radio terminal apparatus having the above-explained structure will be described. In the following descriptions, setting/disconnection of the hands-free communications, and operations in a case of disconnecting the car kit 200, will be explained. FIG. 2 shows a flowchart for explanation of these operations. Control shown in the figure is performed by the control section 160. The control is started when power is turned on, and is repeated until the power is turned off.

First, the control section 160 discriminates whether or not the user requests setting of the hands-free communication function through the key input section 142, at step 2a.

If setting the hands-free communication function is requested, the operation shifts to step 2b. If the setting is not requested, the operation shifts to step 2c.

At step 2b, the control section 160 stores information indicating that the hands-free communication function is set, in the hands-free setting data stored in the memory section 150.

The control section 160 controls the gains of the amplifiers 105 and 108 on the basis of the hands-free gain data stored in the memory section 150, turns up the volume of the speech from the loudspeaker 106, and increases the sensitivity of the microphone 107. The operation shifts to step 2c. The user can thereby make communications without holding the mobile radio terminal apparatus in his hand.

At step 2c, the control section 160 discriminates whether or not the user requests disconnection of the setting of the hands-free communication function through the key input section 142.

If the disconnection is requested, the operation shifts to step 2d. If the disconnection is not requested, the operation shifts again to step 2e.

At step 2d, the control section 160 stores information indicating that the hands-free communication function is not set, in the hands-free setting data stored in the memory section 150.

The control section 160 controls the gain of the amplifier 105 on the basis of the volume setting data stored in the memory section 150 and controls the gain of the amplifier 108 on the basis of the microphone sensitivity data stored therein. The operation shifts to step 2e.

Thus, as the volume of the loudspeaker 106 and the sensitivity of the microphone 107 are set under general conditions, the user can make communications while holding the mobile radio terminal apparatus in his hand.

At step 2e, the control section 160 discriminates whether the car kit 200 is connected or not, on the basis of the information notified by the detector 121.

If the control section 160 discriminates that the car kit 200 is connected, the operation shifts to step 2f. If the control section 160 discriminates that it is not, the operation shifts again to step 2a.

At step 2f, the control section 160 controls the changeover switches 110a and 110b, thereby connecting the D/A converter 104 to the amplifier 205 and connecting the echo cancellation circuit 204 to the A/D converter 111.

The control section 160 sets the gains of the amplifiers 105 and 108 to preset low gains, and the operation shifts to step 2g.

At step 2g, the control section 160 discriminates whether the car kit 200 is disconnected or not, on the basis of the information notified by the detector 121.

If the control section 160 discriminates that the car kit 200 is disconnected, the operation shifts to step 2h. If the control section 160 discriminates that it is not, the operation shifts again to step 2g.

At step 2h, the control section 160 refers to the hands-free setting data stored in the memory section 150 and discriminates whether or not the hands-free communication function is set before the connection of the car kit 200.

If the control section 160 discriminates that the hands-free communication function is set, the operation shifts to step 2i. If the control section 160 discriminates that the hands-free communication function is not set (or the function is released), the operation shifts to step 2j.

At step 2i, the control section 160 controls the changeover switches 110a and 110b, thereby connecting the D/A converter 104 to the amplifier 105 and connecting the band-pass filter 109 to the A/D converter 111.

The control section 160 controls the gains of the amplifiers 105 and 108 on the basis of the hands-free gain data stored in the memory section 150, and the operation shifts to step 2a. The user can thereby make communications without holding the mobile radio terminal apparatus in his hand.

At step 2j, the control section 160 controls the changeover switches 110a and 110b, thereby connecting the D/A converter 104 to the amplifier 105 and connecting the band-pass filter 109 to the A/D converter 111.

The control section 160 controls the gain of the amplifier 105 on the basis of the volume setting data stored in the memory section 150 and controls the gain of the amplifier 108 on the basis of the microphone sensitivity data stored therein. The operation shifts to step 2a.

Thus, the volume of the loudspeaker 106 and the sensitivity of the microphone 107 are set under general conditions, and the user can thereby make communications while holding the mobile radio terminal apparatus in his hand.

As described above, in the mobile radio terminal apparatus having the above structure, the hands-free setting data indicating whether or not the hands-free communication function is set before the connection of the car kit 200, is stored in advance. If the car kit 200 is disconnected, the operations are returned to the conditions before the connection of the car kit 200, on the basis of the hands-free setting data.

Therefore, according to the mobile radio terminal apparatus having the above structure, even if the car kit 200 is connected under the condition that the hands-free communication function is set and then the car kit 200 is disconnected later, the hands-free communication function is set. The user does not need to set again the hands-free communication function, and the apparatus has good usability.

If the car kit 200 is connected under the condition that the hands-free communication function is not set and then the car kit 200 is disconnected later, the hands-free communication function is set. The user does not need to perform the setting of releasing the hands-free communication function, and the apparatus has good usability.

The present invention is not limited to the above-described embodiment.

In the above descriptions, the car kit 200 is used as the external device. However, the present invention is applicable in a case where, for example, the earphone or the like is disconnected, and the same advantage can be obtained in this case.

In addition, the mobile radio terminal apparatus of the above-described embodiment is electrically connected to the car kit 200 through the external interface 120. Instead, for example, the mobile radio terminal apparatus can also be connected to the external device through radio communication.

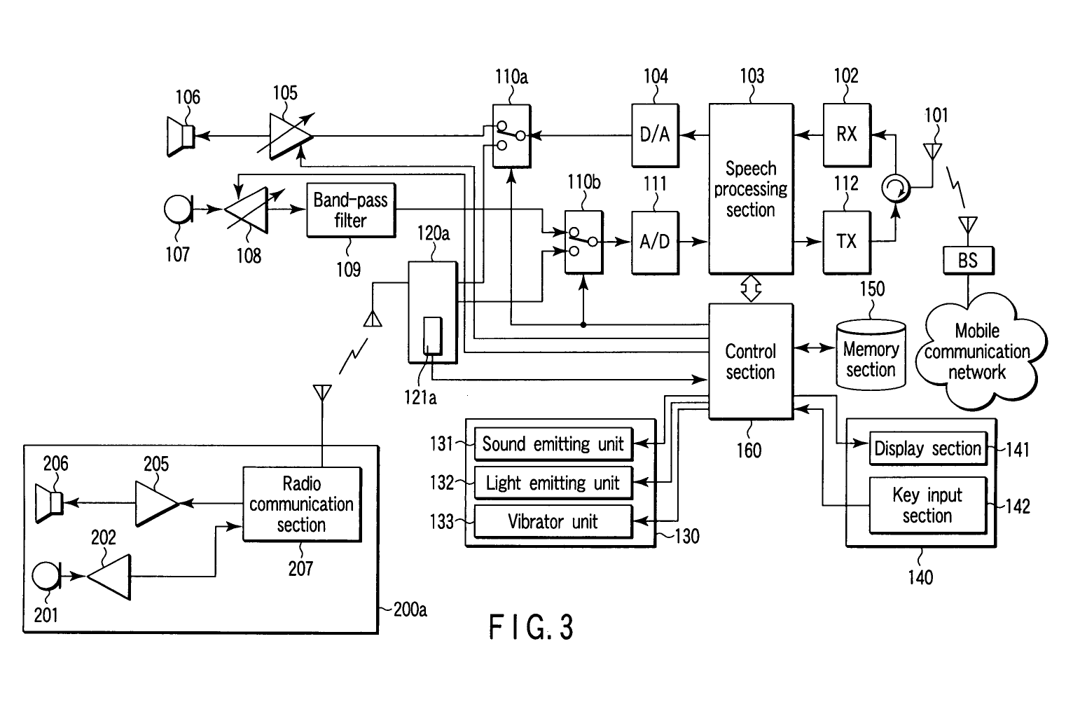

FIG. 3 shows an example of this structure. The mobile radio terminal apparatus comprises a radio communication section 120a instead of the external interface 120. The radio communication section 120a comprises a detector 121a.

A car kit 200a comprises a radio communication section 207. The radio communication section 120a and the radio communication section 207 can make speech communications with each other by radio connection. The detector 121a detects radio connection of the radio communication section 120a with the radio communication section 207 and notifies control section 160 of this detection result.

Thus, even if the mobile radio terminal apparatus is connected to the external device such as the car kit 200a by radio communication, the same advantage can be obtained. A scheme of communications between the radio communication section 120a and the radio communication section 207 may be Bluetooth, wireless LAN, or the like.

Needless to say, the present invention can be variously modified within a range which does not exceed the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication terminal apparatus for making radio communication, comprising:
a speaker;
a microphone;
a first amplifier which varies a level of a speech signal to be outputted by the speaker;
a second amplifier which varies a level of a speech signal inputted by the microphone;
a first memory which stores first information for respectively setting the gains of the first and second amplifiers at predetermined values, and for storing second information for respectively setting the gains of the first and second amplifiers at predetermined values different from the values of the first information;
means for designating any one of the first and second information;
a second memory which stores the information designated by the designating means;
means for controlling the gains of the first and second amplifiers based on the designated information stored in the second memory;
means for connecting to an external device capable of speech input/output;
means for detecting a connection to the external device and a disconnection from the external device; and
means for switching the speech input/output by the microphone and speaker to the speech input/output by the external device when the detecting means detects the connection to the external device, and for switching the speech input/output by the external device to the speech input/output by the microphone and speaker when the detecting means detects the disconnection from the external device;
wherein the controlling means controls the gain of the first and second amplifiers based on the designated information stored in the second memory when the detecting means detects the disconnection from the external device.

2. The communication terminal apparatus according to claim 1, wherein the connecting means connects to the external device through radio communication.

3. A mobile radio terminal apparatus for making radio communication with a base station connectable to a communication network, the terminal apparatus comprising:
a speaker;
a microphone;
a first amplifier which varies a level of a speech signal to be outputted by the speaker;
a second amplifier which varies a level of a speech signal inputted by the microphone;
a first memory which stores first information for respectively setting the gains of the first and second amplifiers at predetermined values, and for storing second information for respectively setting the gains of the first and second amplifiers at predetermined values different from the values of the first information;
means for designating any one of the first and second information;
a second memory which stores the information designated by the designating means;
means for controlling the gains of the first and second amplifiers based on the designated information stored in the second memory;
means for connecting to an external device capable of speech input/output;
means for detecting a connection to the external device and a disconnection from the external device; and
means for switching the speech input/output by the microphone and speaker to the speech input/output by the external device when the detecting means detects the connection to the external device, and for switching the speech input/output by the external device to the speech input/output by the microphone and speaker when the detecting means detects the disconnection from the external device;
wherein the controlling means controls the gain of the first and second amplifiers based on the designated information stored in the second memory when the detecting means detects the disconnection from the external device.

4. The mobile radio terminal apparatus according to claim 3, wherein the connecting means connects to the external device through radio communication.
